(19) United States
(12) Patent Application Publication
(10) Pub. No.: US 2020/0012957 A1
(43) Pub. Date: Jan. 9, 2020

(54) METHOD AND APPARATUS FOR DETERMINING DRIVER'S DROWSINESS AND INTELLIGENT COMPUTING DEVICE

(71) Applicant: LG Electronics Inc., Seoul (KR)

(72) Inventors: Heenam YOON, Seoul (KR); Beomoh KIM, Seoul (KR)

(21) Appl. No.: 16/576,335

(22) Filed: Sep. 19, 2019

(30) Foreign Application Priority Data
Aug. 30, 2019 (KR) 10-2019-0107794

(51) Int. Cl. G06N 5/04; G06N 20/00

(52) U.S. Cl. CPC G06N 5/04; G06N 20/00

(57) ABSTRACT

Provided are a method and apparatus for determining driver's drowsiness. The method for determining driver's drowsiness includes: mapping the biometric data to a drowsiness determination model generated in advance; determining drowsiness of the driver based on a distribution of the biometric data in the drowsiness determination model; detecting first biometric data of the driver at a predetermined first time interval; correcting the biometric data of the driver detected during a time after the first time interval based on a center of distribution of the first biometric data; and determining whether or not the driver drowses based on the corrected biometric data, thereby optimizing the drowsiness determination model for each person/situation using driver data measured on a vehicle.

### CROSS-REFERENCE TO RELATED APPLICATION(S)

This application claims priority under 35 U.S.C. 119 to Korean Patent Application No. 10-2019-0107794, filed on Aug. 30, 2019, the disclosure of which is herein incorporated by reference in its entirety.

### BACKGROUND OF THE INVENTION

### Field of the Invention

The present disclosure relates to a method and apparatus for determining driver's drowsiness and an intelligent computing device, and more particularly, to a method and apparatus for intelligently determining drowsiness for each driver and an intelligent computing device.

### Related Art

A vehicle may be classified into an internal combustion engine vehicle, an external combustion engine vehicle, a gas turbine vehicle, an electric vehicle, and the like according to a type of motor used in the vehicle.

Recently, a smart vehicle has been actively developed for safety or convenience of a driver, a pedestrian or the like, and a study of a sensor mounted on the smart vehicle has been actively conducted. A camera, an infrared sensor, a radar, a global positioning system (GPS), a lidar, a gyroscope, and the like are used in the smart vehicle, and among them, a camera plays a role of the human eye.

According to the development of various sensors and electronic devices, a vehicle having a function of assisting a driver and improving driving safety and convenience has been attracting attention.

Among them, as a necessity of a system for monitoring a driver in order to assist or replace the driver is increased, there is a problem in a function of a drowsiness determination model to determine driver's drowsiness.

### SUMMARY OF THE INVENTION

An object of the present disclosure is to meet the needs and solve the problems.

The present disclosure also provides a method and apparatus for more accurately determining driver's drowsiness by optimizing a drowsiness determination model for each driver and an intelligent computing device.

In an aspect, a method for determining driver's drowsiness includes: detecting biometric data of the driver; mapping the biometric data to a drowsiness determination model generated in advance; and determining drowsiness of the driver based on a distribution of the biometric data in the drowsiness determination model, wherein the mapping of the biometric data include: detecting first biometric data of the driver at a predetermined first time interval; correcting the biometric data of the driver detected during a time after the first time interval based on a center of distribution of the first biometric data; and determining whether or not the driver drowses based on the corrected biometric data.

The method for determining driver's drowsiness may further include: detecting second biometric data of the driver at a predetermined second time interval after the first time interval; and correcting the biometric data of the driver detected during the second time interval based on a direction of distribution change of the second biometric data.

The method for determining driver's drowsiness may further include: outputting a specific voice message to the driver when the biometric data of the driver detected after the second time interval reaches a drowsiness determination plane included in the drowsiness determination model; and updating the drowsiness determination plane based on a response of the driver with respect to the voice message.

in the updating of the drowsiness determination plane, a position of the drowsiness determination plane may be changed.

The voice message may include an inquiry of whether or not the driver drowses, and in the updating of the drowsiness determination plane, the position of the drowsiness determination plane may move based on a response with respect to the inquiry from the driver.

In another aspect, an apparatus for determining driver's drowsiness includes: a communication unit detecting biometric data of the driver; and a processor mapping the biometric data to a drowsiness determination model generated in advance and determining drowsiness of the driver based on a distribution of the biometric data in the drowsiness determination model, wherein the processor detects first biometric data of the driver at a predetermined first time interval, corrects the biometric data of the driver detected during a time after the first time interval based on a center of distribution of the first biometric data, and determines whether or not the driver drowses based on the corrected biometric data.

The processor may detect second biometric data of the driver at a predetermined second time interval after the first time interval and correct the biometric data of the driver detected during the second time interval based on a direction of distribution change of the second biometric data.

The processor may output a specific voice message to the driver when the biometric data of the driver detected after the second time interval reaches a drowsiness determination plane included in the drowsiness determination model and update the drowsiness determination plane based on a response of the driver with respect to the voice message.

The processor may change a position of the drowsiness determination plane.

The voice message may include an inquiry of whether or not the driver drowses, and the processor may move the position of the drowsiness determination plane based on a response with respect to the inquiry from the driver.

In still another aspect, a non-transitory computer-readable medium which is a non-transitory computer-executable component in which a computer-executable component configured to be executed on one or more processors of a computing device is stored, wherein the computer-executable component detects biometric data of a driver; maps the biometric data to a drowsiness determination model generated in advance; determines drowsiness of the driver based on a distribution of the biometric data in the drowsiness determination model; detects first biometric data of the driver at a predetermined first time interval; corrects the biometric data of the driver detected during a time after the first time interval based on a center of distribution of the first biometric data; and determines whether or not the driver drowses based on the corrected biometric data.

### BRIEF DESCRIPTION OF THE DRAWINGS

The accompanying drawings, included as part of the detailed description in order to provide a thorough understanding of the present disclosure, provide embodiments of the present disclosure and together with the description, describe the technical features of the present disclosure.

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an user equipment and a 5G network in a 5G communication system.

FIG. 4 is a block diagram of an AI device according to an embodiment of the present disclosure.

FIG. 5 is a flowchart showing a method for determining driver's drowsiness according to an embodiment of the present disclosure.

FIG. 6 is a view illustrating a drowsiness determination model.

FIG. 7 is a view illustrating a correction example of biometric data using initial data of driving.

FIG. 8 is a view illustrating an example of correcting a direction of distribution change in biometric data.

FIG. 9 is a view illustrating an example of updating a drowsiness determination plane of a drowsiness determination model.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

### A. EXAMPLE OF BLOCK DIAGRAM OF UE AND 5G NETWORK

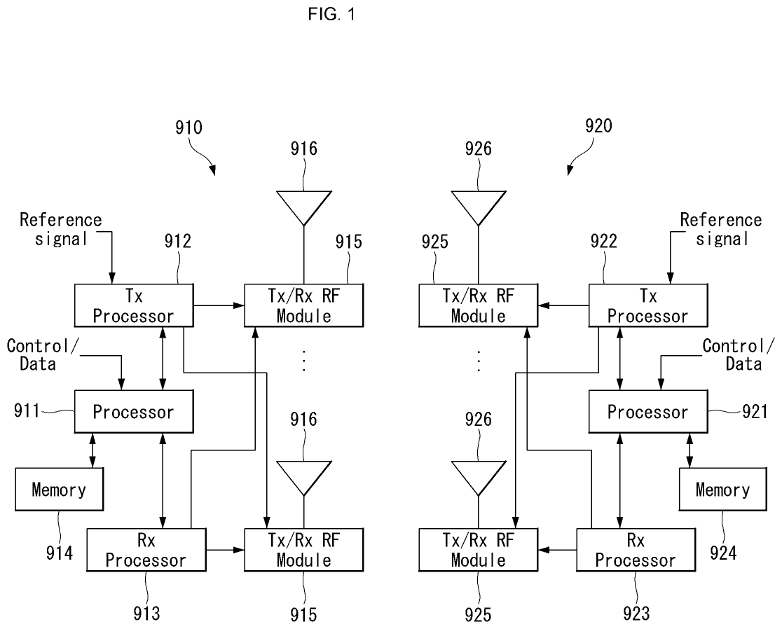

FIG. 1 is a block diagram of a wireless communication system to which methods proposed in the disclosure are applicable.

Referring to FIG. 1, a device (AI device) including an AI module is defined as a first communication device (910 of FIG. 1), and a processor 911 can perform detailed AI operation.

A 5G network including another device (AI server) communicating with the AI device is defined as a second communication device (920 of FIG. 1), and a processor 921 can perform detailed AI operations.

The 5G network may be represented as the first communication device and the AI device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

### B. SIGNAL TRANSMISSION/RECEPTION METHOD IN WIRELESS COMMUNICATION SYSTEM

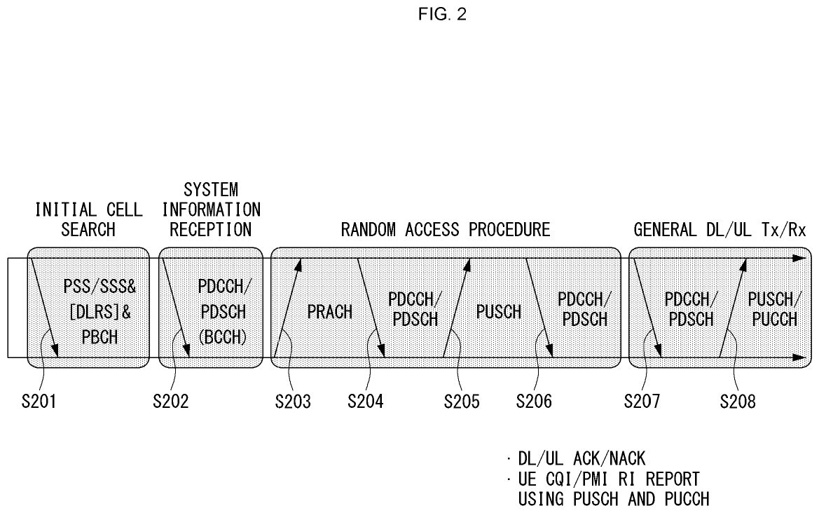

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and obtain information such as a cell ID. In LTE and NR systems, the P-SCH and S-SCH are respectively called a primary synchronization signal (PSS) and a secondary synchronization signal (SSS). After initial cell search, the UE can obtain broadcast information in the cell by receiving a physical broadcast channel (PBCH) from the BS. Further, the UE can receive a downlink reference signal (DL RS) in the initial cell search step to check a downlink channel state. After initial cell search, the UE can obtain more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE obtains time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/obtained through an SSS of the cell, and information on the cell ID among 336 cell ID groups is provided/obtained through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can obtain UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

### C. BEAM MANAGEMENT (BM) PROCEDURE OF 5G COMMUNICATION SYSTEM

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

### D. URLLC (ULTRA-RELIABLE AND LOW LATENCY COMMUNICATION)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionlnDCl by INT-ConfigurationPerServing Cell including a set of serving cell indexes provided by servingCelllD, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

### E. MMTC (MASSIVE MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

### F. BASIC OPERATION OF AI PROCESSING USING 5G COMMUNICATION

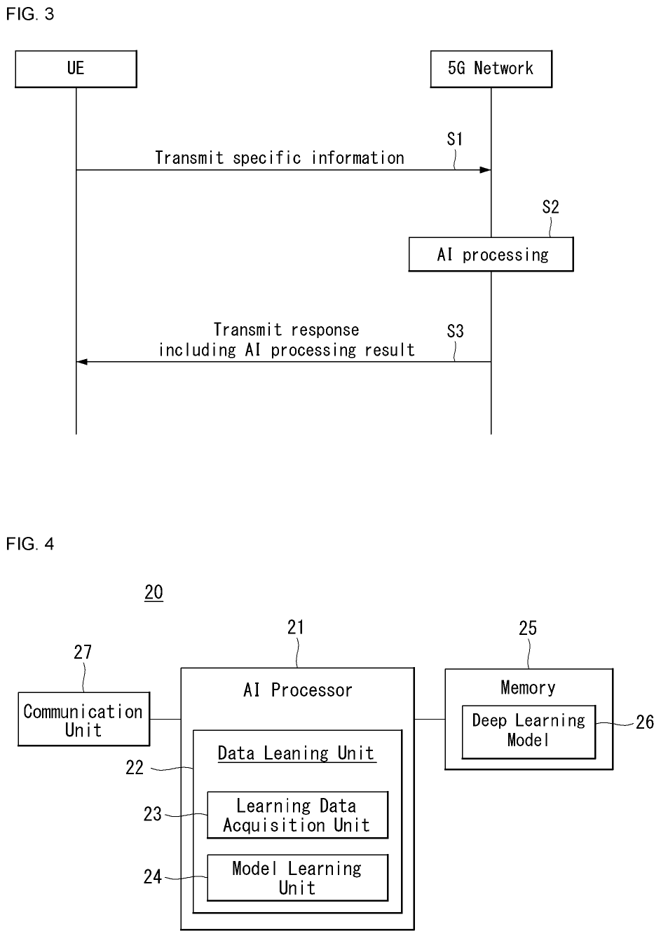

FIG. 3 shows an example of basic operations of AI processing in a 5G communication system.

The UE transmits specific information to the 5G network (S1). The 5G network may perform 5G processing related to the specific information (S2). Here, the 5G processing may include AI processing. And the 5G network may transmit response including AI processing result to UE (S3).

### G. APPLIED OPERATIONS BETWEEN UE AND 5G NETWORK IN 5G COMMUNICATION SYSTEM

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to obtain DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present disclosure which will be described later and applied or can complement the methods proposed in the present disclosure to make technical features of the methods concrete and clear.

FIG. 4 is a block diagram of an AI device according to an embodiment of the present disclosure.

The AI device 20 may include electronic devices including an AI module capable of performing AI processing, a server including the AI module, and the like. Further, the AI device 20 may be included in at least a part of the device 10 shown in FIG. 4 and provided to perform at least some of AI processing together.

The AI processing may include all operations related to control of the device 10 shown in FIG. 4. For example, an autonomous vehicle may carry out the AI processing of sensing data or driver data to process/determine the sensing data or the driver data and perform a control signal generating operation. Further, for example, the autonomous vehicle may carry out the AI processing of data acquired through interaction between other electronic devices provided in the vehicle and perform autonomous driving control.

The AI device 20 may include an AI processor 21, a memory 25, and/or a communication unit 27.

The AI device 20 may be implemented in various electronic devices such as a server, a desktop personal computer (PC), a notebook PC, a tablet PC, and the like as a computing device capable of learning a neural network.

The AI processor 21 may learn the neural network using a program stored in the memory 25. In particular, the AI processor 21 may learn the neural network for recognizing data related to the device. Here, the neural network for recognizing the data related to the device may be designed to simulate a brain structure of human on a computer and include a plurality of network nodes having a weight. The plurality of network nodes may transmit and receive data depending on a connection relationship so as to simulate a synaptic activity of neuron which transmits and receives a signal through a synapse by the neuron. In this case, the neural network may include a deep learning model developed from the neural network model. In the deep learning model, the plurality of network nodes may be located in different layers and transmit and receive data depending on a convolution connection relationship. Examples of the neural network model include various deep learning methods such as deep neural networks (DNN), convolutional deep neural networks (CNN), a recurrent Boltzmann machine (RNN), a restricted Boltzmann machine (RBM), deep belief networks (DBN), and deep Q-network, and the deep learning methods may be applied in fields such as a computer vision, voice recognition, natural language processing, voice/signal processing, and the like.

In other words, the processor performing the function as described above may be a general purpose processor (for example, a central processing unit (CPU)) or an AI dedicated processor (for example, a graphic processing unit (GPU)) for artificial intelligence learning.

The memory 25 may store various programs and data required for an operation of the AI device 20. The memory 25 may be implemented in a non-volatile memory, a volatile memory, a flash memory, a hard disk drive (HDD), a solid state drive (SDD), and the like. The memory 25 is accessed by the AI processor 21, and reading/writing/modifying/erasing/updating of the data acquired by the AI processor 21 may be performed. Further, the memory 25 may store a neural network model (for example, deep learning model 26) generated through a learning algorithm for classifying/recognizing of data according to an embodiment of the present disclosure.

In other words, the AI processor may include a data learning unit 22 learning the neural network for classifying/recognizing of data. The data learning unit 22 may learn a criterion on which learning data is used for determining classification/recognition of data or how to classify and recognize data using the learning data. The data learning unit 22 may acquire learning data being used in learning and apply the acquired learning data to the deep learning model, thereby learning the deep learning model.

The data learning unit 22 may be manufactured in at least one hardware chip and mounted in the AI device 20. For example, the data learning unit 22 may be manufactured in a form of a dedicated hardware chip for artificial intelligence (AI) or mounted in the AI device 20 by being manufactured as a part of general purpose processor (CPU) or graphic dedicated processor (GPU). Further, the data learning unit 22 may be implemented in a software module. In a case where the data learning unit 22 is implemented with the software module (or a program module including an instruction), the software module may be stored in a non-transitory computer readable medium. In this case, at least one of software modules may be provided by an operating system (OS) or an application.

The data learning unit 22 may include a learning data acquiring unit 23 and a model learning unit 24.

The leaning data acquiring unit 23 may acquire learning data required for the neural network model in order to classify and recognize the data. For example, the learning data acquiring unit 23 may acquire vehicle data and/or sample data for inputting the vehicle data and/or sample data into the neural network model as learning data.

The model learning unit 24 may learn to have a determination criterion on how to classify predetermined data of the neural network model using the acquired learning data. Here, the model learning unit 24 may allow the neural network model to learn through supervised learning with at least some of the learning data as the determination criterion. Alternatively, the model learning unit 24 learn by itself using the learning data without supervising, such that the model learning unit 24 may allow the learning network model to learn through unsupervised learning which discovers the determination criterion. Further, the model learning unit 24 may allow the neural network model to learn through reinforcement learning using a feedback on whether or not a result of determining the situation depending on the learning is correct. Further, the model learning unit 24 may allow the neural network model to learn using the learning algorithm including an error back-propagation method or a gradient descent method.

When the neural network model is learned, the model learning unit 24 may store the neural network model in the memory. The model learning unit 24 may store the learned neural network model in the memory of a server connected to the AI device 20 by a wired or wireless network.

The data learning unit 22 may further include a learning data pre-processing unit (not shown) and a learning data selecting unit (not shown) in order to improve a result of analyzing a recognition model or reduce a resource and time for generation of the recognition model.

The learning data pre-processing unit may pre-process the acquired data so that the acquired data is used in learning for determination of the situation. For example, the learning data pre-processing unit may process the acquired data in a preset format so that the model learning unit 24 makes the acquired learning data available in order to learn for image recognition.

Further, the learning data selecting unit may select the data required for learning the learning data acquired in the learning data acquiring unit 23 or the learning data pre-processed in the learning data pre-processing unit. The selected learning data may be provided in the model learning unit 24. For example, the learning data selecting unit may detect a certain region in an image obtained through the camera of the vehicle, such that the learning data selecting unit may select only data for an object included in the certain region.

Further, the data learning unit 22 may further include a model evaluating unit (not shown) for improving the result of analyzing the neural network model.

The model evaluating unit may input evaluation data to the neural network model and allows the model learning unit 22 to learn again when the analysis result output from the evaluation data does not satisfy a predetermined criterion. In this case, the evaluation data may be predefined data for evaluating the recognition model. As an example, when the number or a ratio of evaluation data, in which the analysis result is incorrect, is set in advance, among the analysis results of the recognition model learned for the evaluation data and exceeds a threshold value, the model evaluating unit may evaluate that a predetermined criterion is not satisfied.

The communication unit 27 may transfer the result subjected to the AI processing by the AI processor 21 to an external electronic device.

Here, the external electronic device may be defined as an autonomous vehicle. Further, the AI device 20 may be defined as another vehicle communicated with the autonomous vehicle or a 5G network. On the other hand, the AI device 20 may be functionally embedded and implemented in an autonomous driving module equipped in the vehicle. Further, the 5G network may include a server or a module performing control related to autonomous driving.

In other words, the AI device 20 shown in FIG. 4 are described to be classified into the AI processor 21, the memory 25, the communication unit 27, and the like, but the above components may be integrated into one module and referred to as an AI module.

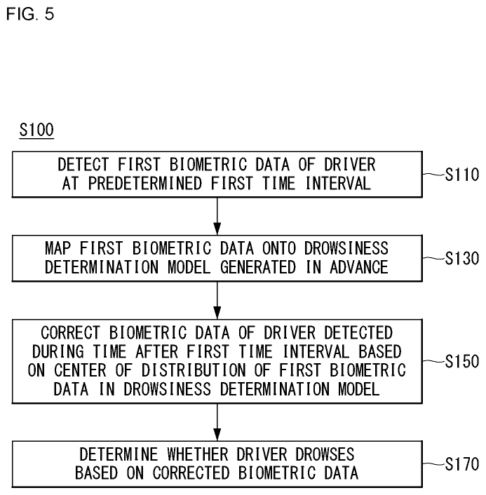

FIG. 5 is a flowchart showing a method for determining driver's drowsiness according to an embodiment of the present disclosure.

As shown in FIG. 5, according to an embodiment of the present disclosure, an apparatus for determining driver's drowsiness may acquire first biometric data of the driver at a predetermined first time interval (S110).

For example, the apparatus for determining driver's drowsiness may be the AI device 20 in FIG. 4. The apparatus for determining driver's drowsiness may detect the first biometric data of the driver from an external device (for example, a vehicle) through the communication unit 27.

Subsequently, the apparatus for determining driver's drowsiness may map the first biometric data onto the drowsiness determination model generated in advance (S130).

The drowsiness determination model is a data distribution model in which the heart rate is set as a Y axis and the number of eye blinks is set as an X axis.

Next, the apparatus for determining driver's drowsiness may correct biometric data of the driver during the time after the first time interval based on a center of distribution of the first biometric data in the drowsiness determination model (S150).

Subsequently, the apparatus for determining driver's drowsiness may determine whether or not the driver drowses based on the corrected biometric data (S170).

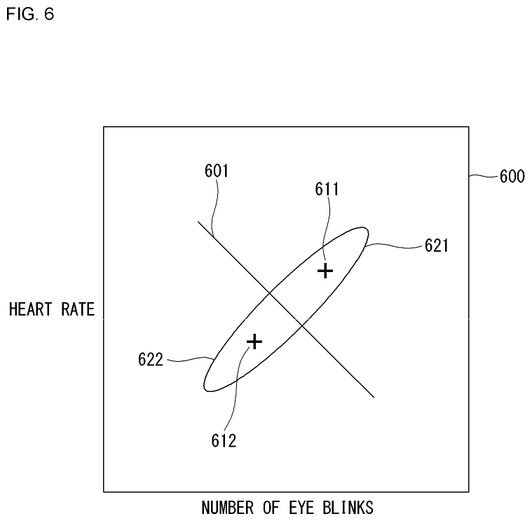

FIG. 6 is a view illustrating a drowsiness determination model.

As shown in FIG. 6, the apparatus for determining driver's drowsiness may measure the biometric data (the number of eye blinks and heart rate) of the driver.

The apparatus for determining driver's drowsiness may map the biometric data of the driver onto a drowsiness determination model 600 consisting of the heart rate and the number of eye blinks.

The apparatus for determining driver's drowsiness may acquire the biometric data of the driver during a specific time interval, map the acquired biometric data of the driver onto the drowsiness determination model, and determine a direction of distribution change of the biometric data of the driver and the center of distribution of the biometric data of the driver depending on a time.

The apparatus for determining driver's drowsiness may determine a center of distribution 611 of the biometric data during the first time interval using biometric data 621 during the first time interval. Further, the apparatus for determining driver's drowsiness may determine a center of distribution 612 of the biometric data during the second time interval using biometric data 622 during the second time interval after the first time interval.

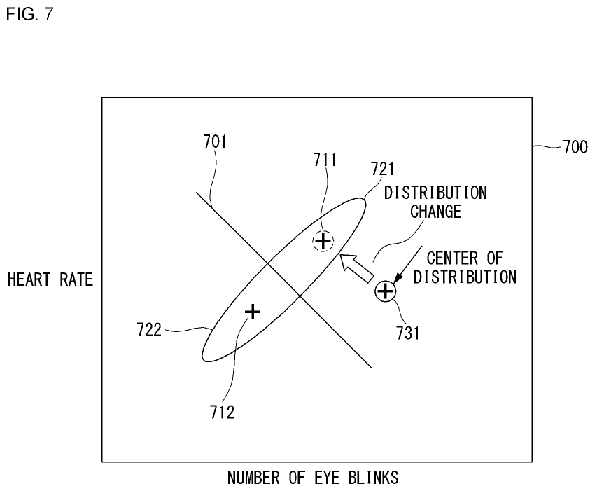

FIG. 7 is a view illustrating a correction example of biometric data using initial data of driving.

As shown in FIG. 7, the apparatus for determining driver's drowsiness may determine a center of distribution 731 of biometric data on a drowsiness determination plane 700 during an internal time interval after the vehicle where the driver is positioned is started.

The apparatus for determining driver's drowsiness may use the center of distribution 731 during the initial time interval and a center of distribution 711 of the drowsiness determination model generated in advance to convert the biometric data acquired after the initial time interval and move the drowsiness determination model generated in advance to the center of distribution 711. For example, the apparatus for determining driver's drowsiness may extract a transform function between the center of distribution 731 of biometric data during the initial time interval and the center of distribution 711 of drowsiness determination model generated in advance and apply, to the extracted transform function, the biometric data (the number of eye blinks and heart rate) acquired after the initial time interval.

In this case, the apparatus for determining driver's drowsiness may confirm the distribution of data, assuming that the initial time interval is an awakened state of the driver.

Further, the apparatus for determining driver's drowsiness may convert the biometric data acquired after the initial time interval based on a center of distribution 712 in an interval of drowsiness 722.

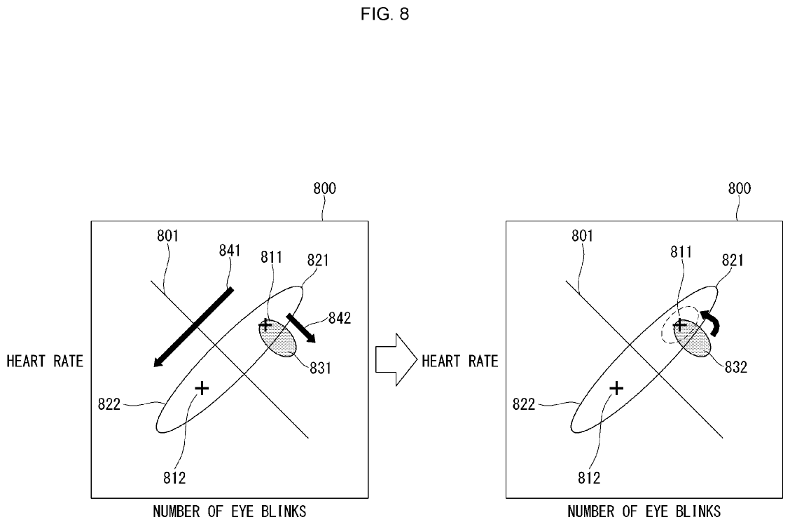

FIG. 8 is a view illustrating an example of correcting a direction in which a distribution of biometric data is changed.

As shown in FIG. 8, a degree of fatigue of the driver is increased depending on an elapse of time.

The apparatus for determining driver's drowsiness recognizes that a direction in change of the biometric data of the driver depending on a time is a direction in which the degree of fatigue is increased and determines that a direction in change of the biometric data of the driver depending on a time is a direction in which drowsiness is increased.

The apparatus for determining driver's drowsiness may acquire a direction of distribution change 842 of biometric data 831 of the driver which is mapped onto a drowsiness determination model 800 during an intermediate time interval after the initial time interval. Subsequently, the apparatus for determining driver's drowsiness may correct the direction of distribution change of biometric data 832 of the driver which is acquired after the intermediate time interval to a direction of distribution change 841 of biometric data in a predetermined drowsiness determination model, based on an angle between the direction of distribution change 841 of biometric data in the predetermined drowsiness determination model and the direction of distribution change 842 of biometric data of the driver during the intermediate time interval.

Likewise, the direction of distribution of biometric data in the vicinity of a center of data distribution 812 in an interval of drowsiness 822 may also be changed.

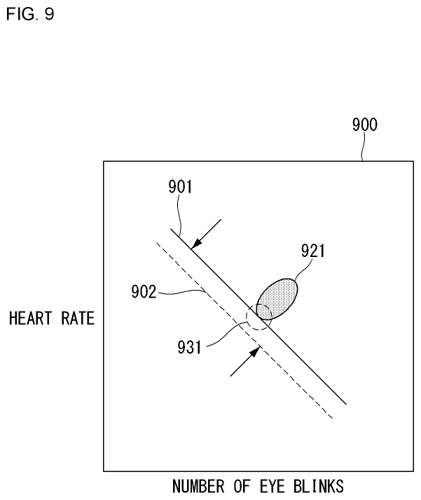

FIG. 9 is a view illustrating an example of updating a drowsiness determination plane of a drowsiness determination model.

As shown in FIG. 9, according to an embodiment of the present disclosure, the apparatus for determining driver's drowsiness may recognize that biometric data 921 of the driver reaches a drowsiness determination plane 901 of a drowsiness determination model 900.

Subsequently, when it is recognized that the biometric data 921 of the driver reaches the drowsiness determination plane 901 of the drowsiness determination model 900, the apparatus for determining driver's drowsiness may output a voice message inquiring to the driver whether or not to drowse.

When a response message that the driver does not drowse is acquired with respect to the voice message inquiring of whether or not to drowse, the apparatus for determining driver's drowsiness may move 902 the drowse determination plane downward.

In contrast, when a response message that the driver drowses is acquired with respect to the voice message inquiring of whether or not to drowse, the apparatus for determining driver's drowsiness may move the drowse determination plane upward.

Here, the drowsiness determination plane may be a plane for classifying the biometric data on the drowsiness determination plane as an awakened state and classifying the biometric data below the drowsiness determination plane as a drowsy state.

### J. SUMMARY OF EXAMPLES

### Example 1

A method for determining driver's drowsiness includes: detecting biometric data of the driver; mapping the biometric data to a drowsiness determination model generated in advance; and determining drowsiness of the driver based on a distribution of the biometric data in the drowsiness determination model, wherein the mapping includes: detecting first biometric data of the driver at a predetermined first time interval; correcting the biometric data of the driver detected during a time after the first time interval based on a center of distribution of the first biometric data; and determining whether or not the driver drowses based on the corrected biometric data.

### Example 2

In Example 1, the method for determining driver's drowsiness may further include: detecting second biometric data of the driver at a predetermined second time interval after the first time interval; and correcting the biometric data of the driver detected during the second time interval based on a direction of distribution change of the second biometric data.

### Example 3

In Example 2, the method for determining driver's drowsiness may further include: outputting a specific voice message to the driver when the biometric data of the driver detected after the second time interval reaches a drowsiness determination plane included in the drowsiness determination model; and updating the drowsiness determination plane based on a response of the driver with respect to the voice message.

### Example 4

In Example 3, in the updating of the drowsiness determination plane, a position of the drowsiness determination plane may be changed.

### Example 5

In Example 4, the voice message may include an inquiry of whether or not the driver drowses, and in the updating of the drowsiness determination plane, the position of the drowsiness determination plane may move based on a response with respect to the inquiry from the driver.

### Example 6

An apparatus for determining driver's drowsiness includes: a communication unit detecting biometric data of the driver; and a processor mapping the biometric data to a drowsiness determination model generated in advance and determining drowsiness of the driver based on a distribution of the biometric data in the drowsiness determination model, wherein the processor detects first biometric data of the driver at a predetermined first time interval, corrects the biometric data of the driver detected during a time after the first time interval based on a center of distribution of the first biometric data, and determines whether or not the driver drowses based on the corrected biometric data.

### Example 7

In Example 6, the processor may detect second biometric data of the driver at a predetermined second time interval after the first time interval and correct the biometric data of the driver detected during the second time interval based on a direction of distribution change of the second biometric data.

### Example 8

In Example 7, the processor may output a specific voice message to the driver when the biometric data of the driver detected after the second time interval reaches a drowsiness determination plane included in the drowsiness determination model and update the drowsiness determination plane based on a response of the driver with respect to the voice message.

### Example 9

In Example 8, the processor may change a position of the drowsiness determination plane.

### Example 10

In Example 9, the voice message may include an inquiry of whether or not the driver drowses, and the processor may move the position of the drowsiness determination plane based on a response with respect to the inquiry from the driver.

### Example 11

A non-transitory computer-readable medium which is a non-transitory computer-executable component in which a computer-executable component configured to be executed on one or more processors of a computing device is stored, wherein the computer-executable component detects biometric data of a driver; maps the biometric data to a drowsiness determination model generated in advance; determines drowsiness of the driver based on a distribution of the biometric data in the drowsiness determination model; detects first biometric data of the driver at a predetermined first time interval; corrects the biometric data of the driver detected during a time after the first time interval based on a center of distribution of the first biometric data; and determines whether or not the driver drowses based on the corrected biometric data.

The present disclosure mentioned in the foregoing description may be implemented in a program recorded medium as computer-readable codes. The computer-readable media include all kinds of recording devices in which data readable by a computer system are stored. Examples of possible computer-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof, and is also realized in the form of a carrier wave (for example, a transmission over the Internet). The above exemplary embodiments are to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

Effects of the method and apparatus for determining driver's drowsiness and the intelligent computing device according to an embodiment of the present disclosure are described as follows.

The present disclosure can optimize the drowsiness determination model for each person/situation using driver data measured on the vehicle.

Further, the present disclosure can more accurately determine whether or not the driver of vehicle drowses using the drowsiness determination model optimized for each person/situation.

Further, the present disclosure can more accurately determine whether or not the driver of vehicle drowses, thereby contributing to the safe driving of the driver.

Effects obtainable from the present disclosure may be non-limited by the above-mentioned effect, and other unmentioned effects can be clearly understood from the following description by those having ordinary skill in the technical field to which the present disclosure pertains.

What is claimed is:

1. An apparatus for determining driver's drowsiness, comprising:
detecting biometric data of the driver;
mapping the biometric data to a drowsiness determination model generated in advance; and
determining drowsiness of the driver based on a distribution of the biometric data in the drowsiness determination model, wherein
the mapping includes
detecting first biometric data of the driver at a predetermined first time interval;
correcting the biometric data of the driver detected during a time after the first time interval based on a center of distribution of the first biometric data; and
determining whether or not the driver drowses based on the corrected biometric data.

2. The method of claim 1, further comprising:
detecting second biometric data of the driver at a predetermined second time interval after the first time interval; and
correcting the biometric data of the driver detected during the second time interval based on a direction of distribution change of the second biometric data.

3. The method of claim 2, further comprising:
outputting a specific voice message to the driver when the biometric data of the driver detected after the second time interval reaches a drowsiness determination plane included in the drowsiness determination model; and
updating the drowsiness determination plane based on a response of the driver with respect to the voice message.

4. The method of claim 3, wherein in the updating of the drowsiness determination plane, a position of the drowsiness determination plane is changed.

5. The method of claim 4, wherein the voice message includes an inquiry of whether or not the driver drowses, and
in the updating of the drowsiness determination plane, the position of the drowsiness determination plane moves based on a response with respect to the inquiry from the driver.

6. An apparatus for determining driver's drowsiness, comprising:
a transceiver detecting biometric data of the driver; and
a processor mapping the biometric data to a drowsiness determination model generated in advance and determining drowsiness of the driver based on a distribution of the biometric data in the drowsiness determination model, wherein
the processor
detects first biometric data of the driver at a predetermined first time interval, corrects the biometric data of the driver detected during a time after the first time interval based on a center of distribution of the first biometric data, and determines whether or not the driver drowses based on the corrected biometric data.

7. The apparatus of claim 6, wherein the processor detects second biometric data of the driver at a predetermined second time interval after the first time interval and corrects the biometric data of the driver detected during the second time interval based on a direction of distribution change of the second biometric data.

8. The apparatus of claim 7, wherein the processor outputs a specific voice message to the driver when the biometric data of the driver detected after the second time interval reaches a drowsiness determination plane included in the drowsiness determination model and updates the drowsiness determination plane based on a response of the driver with respect to the voice message.

9. The apparatus of claim 8, wherein the processor changes a position of the drowsiness determination plane.

10. The apparatus of claim 9, wherein the voice message includes an inquiry of whether or not the driver drowses, and
the processor moves the position of the drowsiness determination plane based on a response with respect to the inquiry from the driver.

11. A non-transitory computer readable medium which is a non-transitory computer-executable component in which a computer-executable component configured to be executed on one or more processors of a computing device is stored, wherein the computer-executable component
detects biometric data of a driver;
maps the biometric data to a drowsiness determination model generated in advance;
determines drowsiness of the driver based on a distribution of the biometric data in the drowsiness determination model;
detects first biometric data of the driver at a predetermined first time interval; corrects the biometric data of the driver detected during a time after the first time interval based on a center of distribution of the first biometric data; and
determines whether or not the driver drowses based on the corrected biometric data.
